(19) United States
(12) Patent Application Publication
(10) Pub. No.: US 2009/0271659 A1
(43) Pub. Date: Oct. 29, 2009

(54) RAID REBUILD USING FILE SYSTEM AND BLOCK LIST

(76) Inventors: Ulf Troppens, Mainz (DE); Nils Haustein, Soergenloch (DE); Daniel James Winarski, Tucson, AZ (US); Craig A. Klein, Tucson, AZ (US)

Correspondence Address: MAXVALUEIP CONSULTING LLC, 11204 ALBERMYRTLE ROAD, POTOMAC, MD, 20854, US

(21) Appl. No.: 12/271,910

(22) Filed: Nov. 16, 2008

Related U.S. Application Data
(63) Continuation of application No. 12/108,511, filed on Apr. 24, 2008, now abandoned.

(51) Int. Cl. G06F 11/20

(52) U.S. Cl. 714/7; 714/E11.095

(57) ABSTRACT

This embodiment (a system) addresses and reduces the RAID build time by only rebuilding the used blocks and omitting the unused blocks. This starts after a disk drive from a RAID system is failed and replaced and storage controller starts the process of rebuilding the data on the new disk drive. Storage controller determines the logical volumes that must be rebuilt, send a message requesting only used blocks for these logical volumes from the volume manager and then uses this information and only rebuild the used blocks for the failed disk system.

This is a Cont. of another Accelerated Exam. application Ser. No. 12/108,511, filed Apr. 24, 2008, to issued in November 2008, as a US Patent, with the same title, inventors, and assignee, IBM.

### BACKGROUND OF THE INVENTION

Disk drives fail because of errors ranging from bit errors, bad sectors which sector cannot be read, to complete disk failures. It is possible to increase the reliability of a single disk drive, this however increases the cost. Through a suitable combination of lower-cost disk drives, it is possible to significantly increase the fault-tolerance of the whole system.

One of the design goals of Redundant Array of Independent Disks (RAID) is to increase the fault tolerance against such failures by redundancy. The variations of RAID are called RAID levels. All RAID levels aggregate multiple physical disks and use its capacity to provide a virtual disk, the so called RAID array. Some RAID levels such as RAID 1 and RAID 10 mirror all data where if a disk drive fails a copy of the data is still available on the respective mirror disk. Other RAID levels such as RAID 3, RAID 4, RAID 5, RAID 6, and Sector Protection through Intra-Drive Redundancy (SPIDRE) organize the data in groups (stripe sets) and calculates parity information for that group. If a disk drive fails, its data can be reconstructed from the disk drives that remain intact.

Once a defective disk drive is replaced, the RAID controller rebuilds the data of the failed disk and stores it on the replaced one. This process is called RAID rebuild. The RAID rebuild of some RAID levels such as RAID 3, RAID 4, RAID 5, RAID 6, and SPIDRE depends on reading the data of all remaining disk drives. Depending on the size of the RAID array this can take several hours.

A RAID rebuild impacts all applications which access data on the RAID array in rebuild thus a RAID array in rebuild mode is called “degraded”. The RAID rebuild consumes a lot of resources of the RAID array such as disk I/O capacity, I/O bus capacity between the disks and the RAID controller, RAID controller CPU capacity, and RAID controller cache capacity. The resource consumption of the RAID rebuild impacts the performance of application I/O.

Furthermore, the high availability of a degraded RAID array is at risk. RAID 4 and RAID 5 do not tolerate the failure of a second disk and RAID 6 and SPIDRE do not tolerate the failure of a third disk while the rebuild is in progress. Prior art supports the tuning of the priority of RAID rebuild in contrast to the priority of application I/O. That means increased application I/O can be traded for a longer rebuild time. However, a longer rebuild time exposes the data due to the reduced fault tolerance of a degraded RAID array. We want to reduce the time required for a RAID rebuild.

### SUMMARY OF THE INVENTION

This is an embodiment of a system that addresses and reduces the RAID build time by only rebuilding the used blocks of the failed drive and omitting the unused blocks. This method starts after a disk drive from a RAID system is failed and replaced and storage controller starts the process of rebuilding the data on the new disk drive.

First, storage controller determines all the logical volumes that were mapped into the failed drive. Then, it determines if the system supports communication between the storage controller and volume manager on the host system. If this communication is not available, storage controller rebuilds all the blocks for all the logical volumes.

If this communication is available, storage controller sends a request message to volume manager to report all the used blocks for all the logical volumes to storage controller. Once volume manager receives this request message, it calculates all the used blocks for all the requested logical volumes and reports back through a message to storage controller.

Storage controller receives the message with used block list content and rebuilds the corresponding blocks. Next, storage controller rebuilds the parity blocks for the new drive and finally rebuilds the stripe sets for the storage system.

### BRIEF DESCRIPTION OF THE DRAWINGS

FIG. 1 is a depiction of distributed RAID system.

FIG. 2 is the main flow diagram of enhanced RAID volume rebuild process.

FIG. 3 is the flow diagram of volume manager actions.

FIG. 4 is the continuation of the flow diagram for enhanced RAID rebuild when storage controller receives message from volume manager.

FIG. 5 is the flow diagram of enhanced RAID rebuild if no communication between volume manager and storage controller is available.

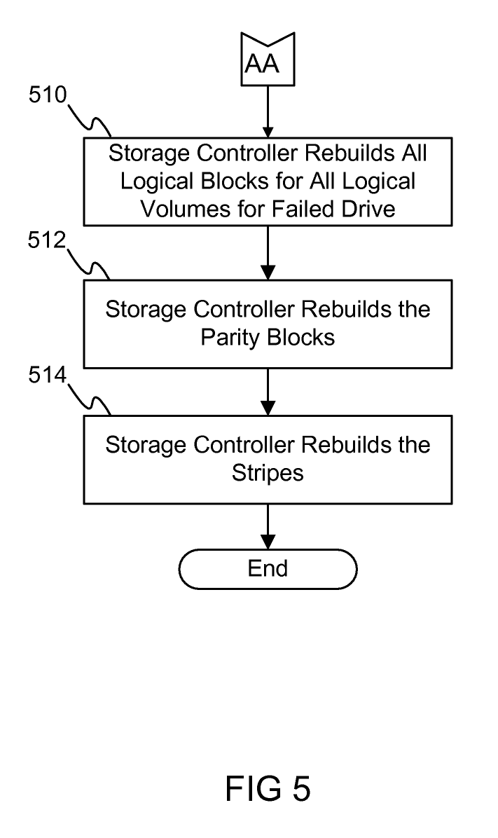

### DETAILED DESCRIPTION OF THE PREFERRED EMBODIMENTS

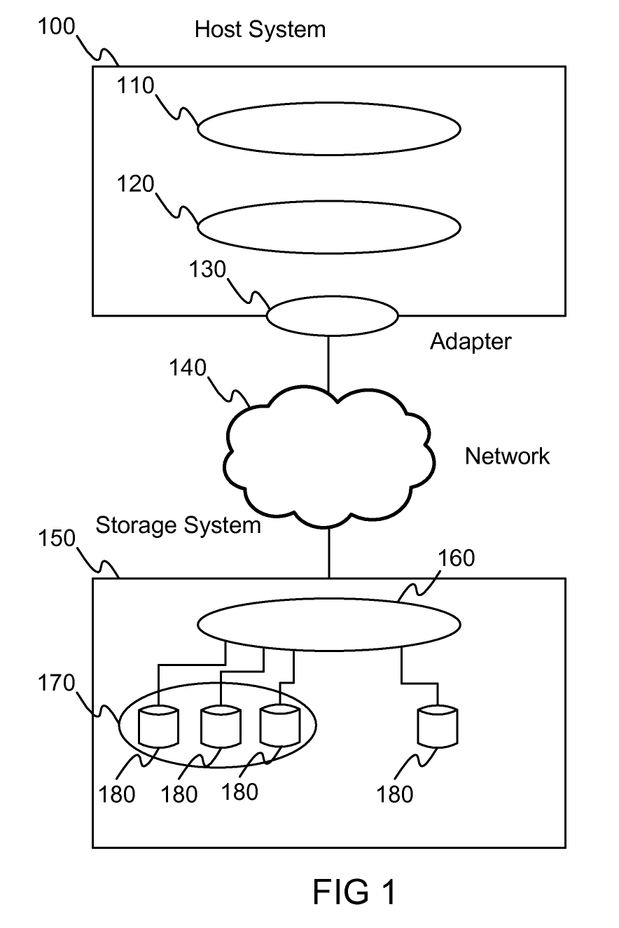

This embodiment of a system and method addresses and reduces the RAID build time by only rebuilding the used blocks of the failed drive and omitting the unused blocks. Referring to FIG. 1, this distributed system is comprised of host system (100) which is represented by a computer system comprising of an application (110), volume manager (120) and adapter (130). Application (110) utilizes volume manager (120) to read and write data. Volume manager usually represents a file system interface to application. Application uses the file system interface to read files from and write files to storage system (150).

Volume manager translates the file read and write operations to read and write commands, such as Small Computer System Interface (SCSI) read and write commands and are issued via adapter (130) instructing storage system to read or write data. Adapter is connected to network (140) interconnecting the host system to the storage system. Network (140) could be a storage network (e.g. SAN), such as Fibre Channel, Fibre Channel over Ethernet (FCoE), or local area network (LAN), facilitating protocols, such as TCP/IP and Internet SCSI (iSCSI).

Storage system (150) comprises of storage controller (160) comprising processes to read and write data to the storage media (1 80). Storage system further comprises storage media where the data is stored. Multiple storage media can be combined to represent one RAID array. Furthermore, storage system may comprise methods to represent one or more storage media as a logical volume (170) to the host system. Logical volume can be part of a RAID array or single disk. One RAID array may comprise one or more logical volumes. Logical volume comprises a plurality of logical blocks. Each logical block is addressed by a logical block address (LBA). The volume manager uses LBA to address data stored in logical blocks for reading and writing.

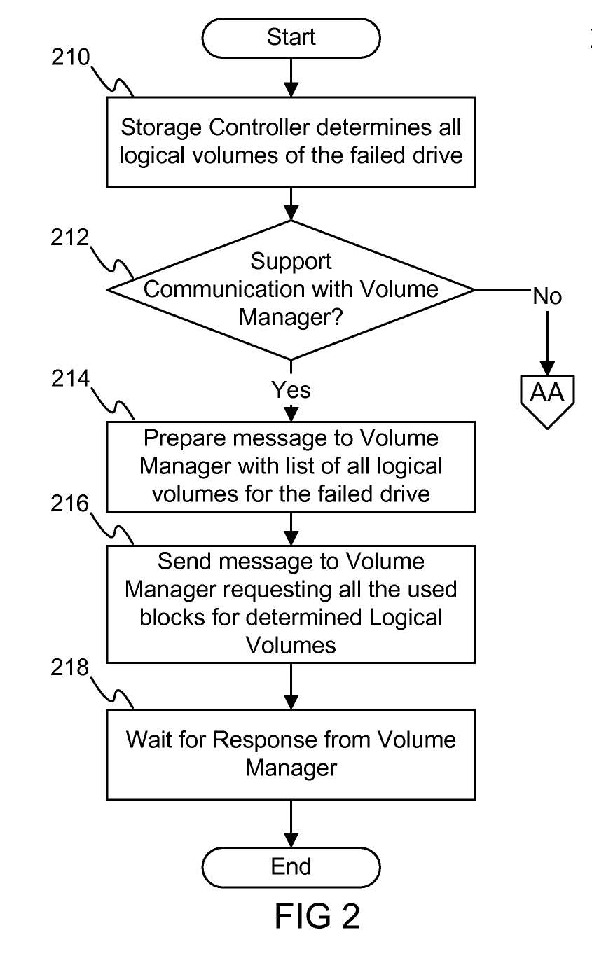

The process starts after a RAID storage media is failed and the failed drive is replaced and distributed system is in degraded mode and rebuild logical volumes for the failed drive is starting. Referring to FIG. 2, storage controller determines all the logical volumes for the failed drive (210), and then determines if the distributed system supports communication to volume manager (212). If no such communication is supported, storage controller rebuilds all logical blocks for all logical volumes of the failed drive (510). Storage controller then continues with the normal process of building the parity blocks (512) and finally building the RAID stripe sets (514).

If communication between the storage controller and volume manager is supported (212), storage controller prepares a message to volume manager with the list of all logical volumes for the failed drive (214). Storage controller sends the message to volume manager requesting a list of all used logical blocks for these logical volumes (216) and waits for the message back from the volume manager (218).

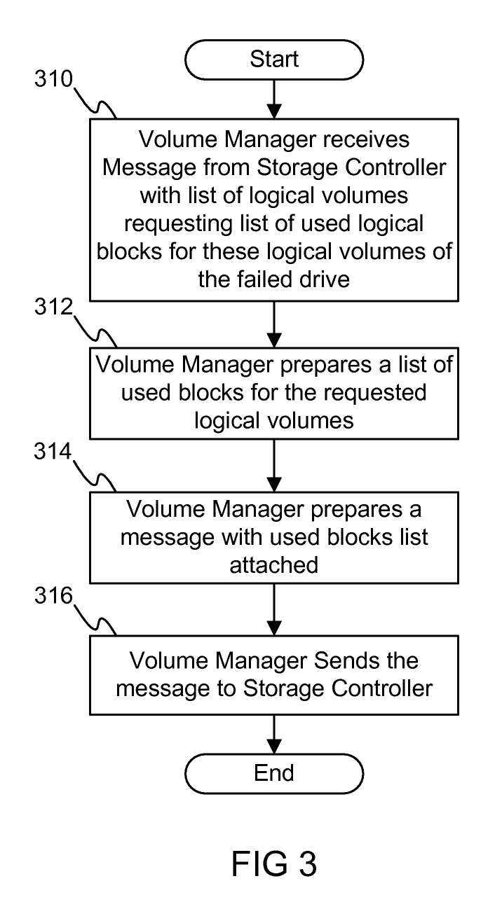

Referring to FIG. 3, volume manager receives a message from storage controller requesting used logical blocks (3 10). Volume manager determines and prepares the list of used logical blocks (312) and prepares a message for Storage controller with this information (314). Volume manager send the message to storage controller with the list of used logical blocks (316).

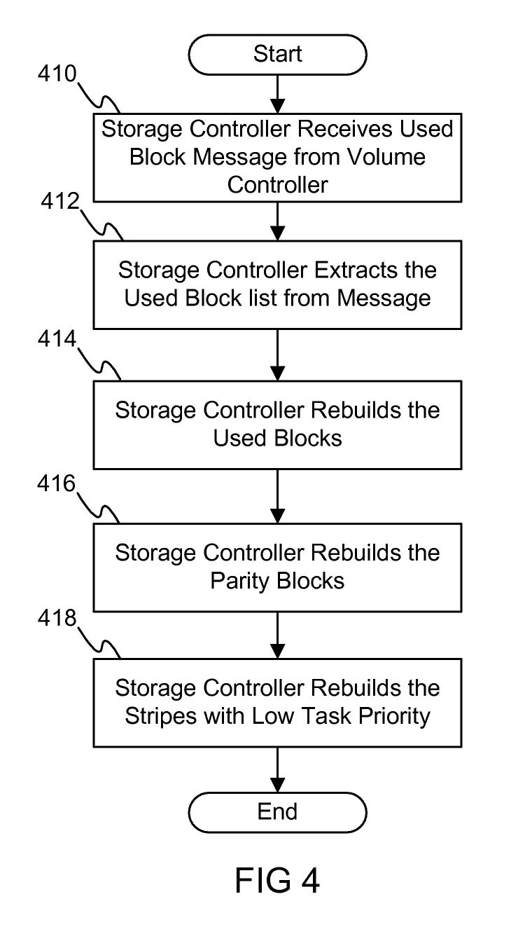

Referring to FIG. 4, storage controller receives used block message from volume manager (410). Storage controller extracts the list from the message (412) and starts to build the logical blocks per received list (414). Storage controller continues to build the parity blocks (416) and finally builds the RAID stripe sets (418). In one embodiment, building the RAID stripe sets is performed via a low priority task.

Another embodiment is a method for redundant arrays of independent disks rebuild using used block list propagation in a distributed storage system, wherein the distributed storage system comprising a computer system, a first storage system, and a network system, wherein the computer system comprises an application, a volume manager, an adaptor, wherein the application uses the volume manager to read and write data to the first storage system, wherein the first storage system comprises a storage controller, and a plurality of storage media, wherein the adaptor translates the volume manager's read and write commands to specific first storage system read and write commands, wherein the network system comprises of a local area network, wherein the distributed storage system comprises a redundant arrays of independent disks system or a storage area network system, wherein the method comprising:

In case of degrading mode of first storage media of the plurality of storage media failing, replacing the first failing storage media; the storage controller determining all logical volumes of the first failing storage media, wherein each of the logical volumes is a plurality of logical blocks; the storage controller determining support for communication with the volume manager of the computer system.

If the storage controller does not support communicating with the volume manager, the storage controller calculating the logical blocks of all the logical volume, the storage controller rebuilding the logical blocks, the storage controller rebuilding all storage system stripes.

If the storage controller does support communicating with the volume manager, the storage controller sending message to the volume manager over the network system, wherein the message is requesting all used logical blocks, wherein the used logical blocks are all used the logical blocks for the logical volume for the first failing storage media, wherein the message includes the logical volume for the first failing storage media; the volume manager receiving the message; the volume manager extracting the logical volume from the message.

The volume manager calculating all the used logical blocks for the logical volume; the volume manager creating a list of the used logical blocks, wherein the list includes all calculated the used logical blocks; the volume manager creating second message, wherein the second message includes the list; the volume manager sending the second message to the storage controller over the network system.

The storage controller receiving the second message from the volume manager over the network system; the storage controller extracting the list from the second message; the storage controller extracting the used logical blocks from the list; the storage controller rebuilding the logical volume from the used logical blocks; and the storage controller rebuilding all the storage system stripes with low task priority.

A system, apparatus, or device comprising one of the following items is an example of the invention: RAID, storage, computer system, backup system, controller, SAN, applying the method mentioned above, for purpose of storage and its management.

Any variations of the above teaching are also intended to be covered by this patent application.

1. A system for rebuilding a redundant array of independent disks using used block list propagation in a distributed storage module in a first network, said system comprising:
a computer module; and
a first storage module;
wherein said computer module comprises an application, a volume manager, an adaptor,
said application uses said volume manager to read and write data to said first storage module,
said first storage module comprises a storage controller, and a plurality of storage media,
said adaptor translates said volume manager's read and write commands to specific said first storage module read and write commands,
said first network comprises a local area network,
in case of degrading mode of first storage media of said plurality of storage media failing,
said first failing storage media is replaced;
said storage controller determines all logical volumes of said first failing storage media, wherein each of said logical volumes is a plurality of logical blocks;
said storage controller determines support for communication with said volume manager of said computer module;
if said storage controller does not support communicating with said volume manager, said storage controller calculates said logical blocks of all said logical volume,
said storage controller rebuilds said logical blocks, said storage controller rebuilds all storage module stripes; if said storage controller does support communicating with said volume manager,
said storage controller sends message to said volume manager over said first network,
said message is requesting all used logical blocks,
said used logical blocks are all used said logical blocks for said logical volume for said first failing storage media,
said message includes said logical volume for said first failing storage media;
said volume manager receives said message;
said volume manager extracts said logical volume from said message;
said volume manager calculates all said used logical blocks for said logical volume;
said volume manager creates a list of said used logical blocks, wherein said list includes all calculated said used logical blocks;
said volume manager creates second message, wherein said second message includes said list;
said volume manager sends said second message to said storage controller over said first network;
said storage controller receives said second message from said volume manager over said first network;
said storage controller extracts said list from said second message;
said storage controller extracts said used logical blocks from said list;
said storage controller rebuilds said logical volume from said used logical blocks; and
said storage controller rebuilds all said storage module stripes with low task priority.
